(19) United States
(12) Patent Application Publication
(10) Pub. No.: US 2007/0195681 A1
(43) Pub. Date: Aug. 23, 2007

(54) Signal generating circuit of optical disc recording/reproducing apparatus

(75) Inventor: Naoki Yumiyama, Ehime (JP)

Correspondence Address: STEPTOE & JOHNSON LLP, 1330 CONNECTICUT AVE., NW, WASHINGTON, DC, 20036, US

(73) Assignee: MATSUSHITA ELECTRIC INDUSTRIAL CO., LTD., OSAKA (JP)

(21) Appl. No.: 11/631,848

(22) PCT Filed: Jul. 14, 2005
(86) PCT No.: PCT/JP05/13071

§ 371 Date: Jan. 8, 2007

(30) Foreign Application Priority Data
Jul. 30, 2004 (JP) 2004-222663

(51) Int. Cl. G11B 7/00

(52) U.S. Cl. 369/124.12; 369/59.15

(57) ABSTRACT

An optical disc recording/reproducing apparatus capable of performing a stable reading of address information. A signal generating circuit for detecting a wobble signal based on a meander of the recording area of an optical disc, comprising a lowpass filter (LPF) (15) for passing therethrough only those lower parts of the frequencies of signals from a light receiving element of an optical pickup which are near a wobble signal band, or a bandpass filter (BPF) (16) for passing therethrough only those frequencies of the signals from the light receiving element which are within a predetermined range of a wobble signal frequency band, wherein the LPF (15) or BPF (16) is used to eliminate the affect of record pulses superimposed on the signals from the light receiving element, thereby reducing address information acquisition errors due to the affection of noise and hence obtaining a stable recording operation.

### TECHNICAL FIELD

The present invention relates to a signal generating circuit of an optical disc recording/reproducing apparatus, more particularly, a signal generating circuit during a data recording operation.

### BACKGROUND ART

In a known optical disc recording/reproducing apparatus, an optical pickup laser beam is radiated to a signal surface of an optical disc and a reflected light is received by 4-division light receiving element. An error signal used to control an actuator such as a focus error signal or a tracking error signal or a wobble signal used for acquire address information is generated by using a predetermined difference in output from the light receiving element after an I-V conversion is performed for the output from the 4-division light receiving element.

The optical disc recording/reproducing apparatus records data in a recordable optical disc by using the error signal or the wobble signal or reproduces data recorded in the recordable optical disc.

For the error signal, a servo circuit is formed to drive a focus coil or a tracking coil of an optical pickup actuator through a phase compensating circuit or a drive circuit. In addition, for the wobble signal, the optical pickup moves to a predetermined position by acquiring address information required for accurately performing a position control of the optical pickup and a rotation control of a spindle motor at the time of recording and reproducing operations in the recordable optical disc and a pit is accurately recorded by controlling a rotation speed of the spindle motor with information required for the rotation control of the optical disc.

That is, when address information cannot be normally detected by the wobble signal, a rotation of the optical disc and synchronization with data cannot be performed. Therefore, there is a possibility that a failure will occur in recording. In particular, in an unrewritable recording media such as a CD-R, in case of the failure in recording, there are many possibilities that the CD-R will not be used. Accordingly it is very important to detect accurate address information and control the actuator during the recording operation.

The power of the laser beam is constant during reproducing in the optical disc. However, at the time of recording in the recordable optical disc including the CD-R, a CD-RW, a DVD-R, and a DVD-RW, since the laser beam of the optical pickup generates a pit array of an EFM signal, the power of the laser beam is changed. When the power is changed, a loop gain of the servo circuit is varied and a signal level is varied in the wobble signal, thereby obstructing a stable recording operation. Therefore, at the time of recording data in the optical disc, a sample-hold circuit is used for sample-holding the output from the light receiving element.

FIG. 6 shows a wobble signal generating circuit using such known sample-hold circuit and FIG. 7 shows a servo signal generating circuit. In addition, FIG. 5 is a block diagram showing a configuration of an optical pickup light receiving element part. As shown in FIG. 5, an optical pickup light receiving element 1 includes 4-division light receiving elements A, B, C, and D positioned in a groove and two 4-division light receiving elements (E1, E2, E3, and E4) and (F1, F2, F3, and F4) positioned in both radius directions of the optical disc. Respective output currents of the optical pickup light receiving elements A, B, C, and D are converted to voltage output signal MA, MB, MC, and MD by an I-V converter 2. In addition, respective output currents (E1 or F1), (E2 or F2), (E3 or F3), and (E4 or F4) of the optical pickup light receiving element at the same position are converted to voltage output signals SE, SF, SG, and SH by the I-V converter 2 and output to the wobble signal generating circuit of FIG. 6 and the servo signal generating circuit of FIG. 7.

First, a sample-hold circuit 6 shown in FIGS. 6 and 7 will be described.

The sample-hold circuit 6 outputs an input voltage to an output terminal through an input terminal and collects the input voltage in a condenser when a sample pulse circuit 5 is in H. The sample hold circuit 6 opens the input terminal and the output terminal, and outputs the voltage of the condenser when the sample pulse signal 5 is in L.

Next, a wobble generating circuit shown in FIG. 6 will be described.

In the output signals MA, MB, MC, and MD of the I-V converter 2, the output signals MA and MD are added to each other, and the output signals MB and MC are added to each other, thereby each being input to a VGA circuit 7. A gain-up or a gain-down of a predetermined amount is performed in the VGA circuit 7, each being input to the sample-hold circuit 6. Each output voltage of the sample-hold circuit 6 described above is converted a predetermined voltage by a VGA circuit 8. After the output voltage of the VGA circuit 8 is subtracted by an error amplifier 9 and amplitudes thereof are adjusted by a VGA circuit 10, an only signal of a wobble signal frequency band is extracted to a BPF 11, thereby generating a wobble signal 4. The wobble signal 4 is described by the following expression:
(MA+MD)−(MB+MC)=Wobble Signal 4 (1)

As described above, JP-A-2002-100041 discloses a method of extracting the only signal of the wobble signal frequency band to the BPF 11 from signals acquired through the subtraction by the error amplifier 9.

Next, a servo signal generating circuit 12 of FIG. 7 will be described.

After the gain-up or the gain-down of a predetermined amount of the output signals MA, MB, MC, and MD of the I-V converter 2 is performed, the output signals are input to the sample-hold circuit 6. The output signals (SMA, SMB, SMC, and SMD) and (SSE, SSF, SSG, and SSH) of the sample-hold circuit 6 described above each are input to an error signal generating circuit 14. The following expression is applied to the output signals, thereby outputting servo control signals. For example, the expressions are:
(SMA+SMD)−(SMB+SMC)−(SSE+SSG)−(SSF+SSH)=Tracking Error Signal (2)
(SMA+SMC)−(SMB+SMD)+(SSE+SSH)−(SSF+SSG)=Focus Error Signal (3)

Formula (2) is the expression of the tracking control signal and formula (3) is the expression of the focus control signal.

FIG. 8A shows an output signal of the I-V converter 2, FIG. 8B shows a sample pulse signal 5, and FIG. 8C shows an output signal of the sample-hold circuit 6. FIG. 9E is an enlarged view of the output signal of the I-V converter 2 shown in FIG. 8A, FIG. 9F is an enlarged view of the sample pulse signal 5 shown in FIG. 8B, and FIG. 9G is an enlarged view of the output signal of the sample-hold circuit 6 shown in FIG. 8C.

### DISCLOSURE OF THE INVENTION

### Problem to be Solved by the Invention

As shown in FIG. 9E, after the ascent and the descent of an I-V converter 2, a ringing h is generated. Accordingly, since a signal including the ringing h is output after a sample-hold operation of a known sample-hold circuit 6, the signal includes a wobble signal 4 and each control signal includes a noise i. In addition, when a sampling operation is performed in a pattern excluding the ringing h part, a section j where the sampling operation can be performed is narrowed and a difference from an actual signal increase. Therefore, there is a high possibility for malfunction.

Actually, in a high double speed recording such as a recording of 24 double speed or higher, a radiation power for recording increases and a ringing section k increases. Accordingly, the sample section j is narrowed and a noise occurs in a recorded servo signal, there is a problem that a recording operation is not stable. In addition, for the wobble signal 4, there is a problem that an acquisition error increases due to the affect of the noise I, similarly with the control signal.

Consequently, an object of the present invention is to provide a signal generating circuit of an optical disc recording/reproducing apparatus capable of performing a stable reading and tracking of address information, and an actuator control.

### Means for Solving the Problem

To achieve the object, in the present invention, a signal generating circuit of an optical disc recording/reproducing apparatus for detecting a wobble signal based on a meander of a recording area, on the basis of signals of a light receiving element of an optical pickup which receives a reflective light from a recording surface of a spot light radiated to an optical disc where the recording area is formed in a spiral pattern or in a concentric pattern, the signal generating circuit including one of a lowpass filter for passing only lower parts of frequencies close to a wobble signal band according to the signals of the light receiving element and a bandpass filter for passing only frequencies within a predetermined range of a wobble signal frequency band according to the signals of the light receiving element, wherein an affect of record pulses superimposed on the signals from the light receiving element is eliminated by the lowpass filter or the bandpass filter.

In the present invention, the sample-hold circuit for sampling the signals of the light receiving element is provided, wherein output signals of the sample-hold circuit are input to one of the lowpass filter and the bandpass filter, a variation area by a recording power is eliminated by the sample-hold circuit according to the signals from the light receiving element, and a ringing frequency upon ascent and descent by a level variation is eliminated by the lowpass filter and the bandpass filter according to the signals of the sample-hold circuit.

In the present invention, a signal generating circuit of an optical disc recording/reproducing apparatus for generating and outputting an error signal representing a relative error involved in a control of a laser beam to an information surface of an optical disc, based on signals of the light receiving element of an optical pickup for radiating a spot light to an information recording surface of a recordable optical disc and detecting a reflective light from the information recording surface, the signal generating circuit including one of a lowpass filter for passing only lower parts of frequencies where an actuator control can be performed according to the signals of the light receiving element and a bandpass filter for passing only frequency band where the actuator control can be controlled according to the signals of the light receiving element, wherein an affect of record pulses superimposed on the signals from the light receiving element is eliminated by the lowpass filter or the bandpass filter.

In the present invention, the sample-hold circuit for sampling the signals of the light receiving element is provided, wherein output signals of the sample-hold circuit are input to one of the lowpass filter and the bandpass filter, a variation area by a recording power is eliminated by the sample-hold circuit according to the signals of the light receiving element, and a ringing frequency upon ascent and descent by a level variation is eliminated by the lowpass filter and the bandpass filter according to the signals of the sample-hold circuit.

### Effect of the Invention

In the present invention, by this configuration, since an acquisition error of address information decreases and a noiseless servo signal can be generated, there is an advantage that a stable recording operation can be obtained.

### BRIEF DESCRIPTION OF THE DRAWINGS

FIG. 1 is a block diagram of a wobble signal generating circuit of an optical disc recording/reproducing apparatus according to a first embodiment of the present invention.

FIG. 2 is a block diagram of a servo signal generating circuit of an optical disc recording/reproducing apparatus according to a second embodiment of present invention.

FIG. 3 is a block diagram of a wobble signal generating circuit of an optical disc recording/reproducing apparatus according to a third embodiment of the present invention.

FIG. 4 is a block diagram of a servo signal generating circuit of an optical disc recording/reproducing apparatus according to a fourth embodiment of present invention.

FIG. 5 is a block diagram illustrating a configuration of an optical pickup light receiving element part.

FIG. 6 is a block diagram illustrating problems related to a wobble signal generating circuit.

FIG. 7 is a block diagram illustrating problems related to a servo signal generating circuit.

FIGS. 8A to 8D are signal waveform diagrams respectively showing signals of a wobble signal generating circuit and a servo signal generating circuit.

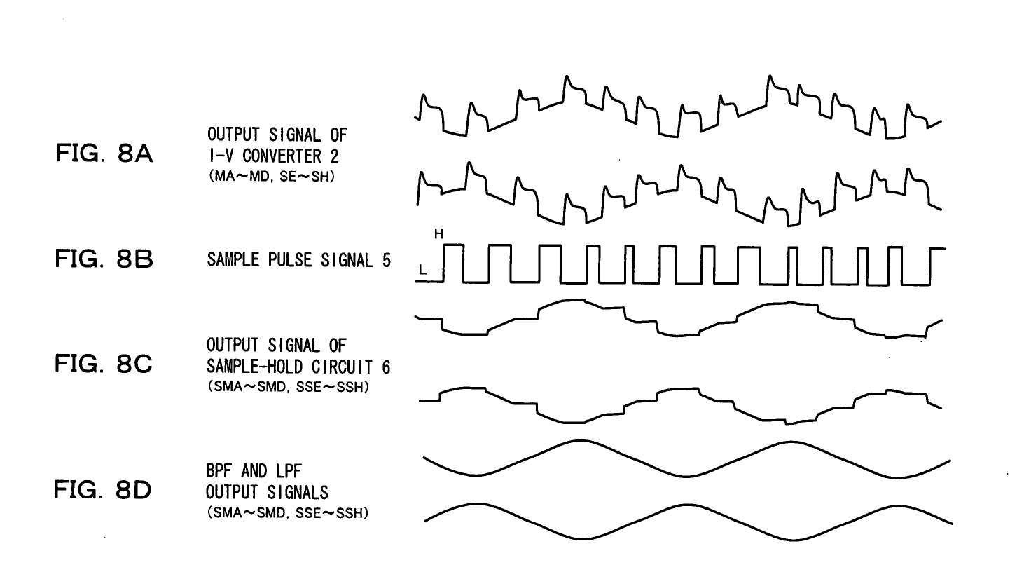

FIGS. 9E to 9G are signal waveform diagram respectively illustrating problems related to a wobble signal generating circuit and a wobble signal generating circuit.

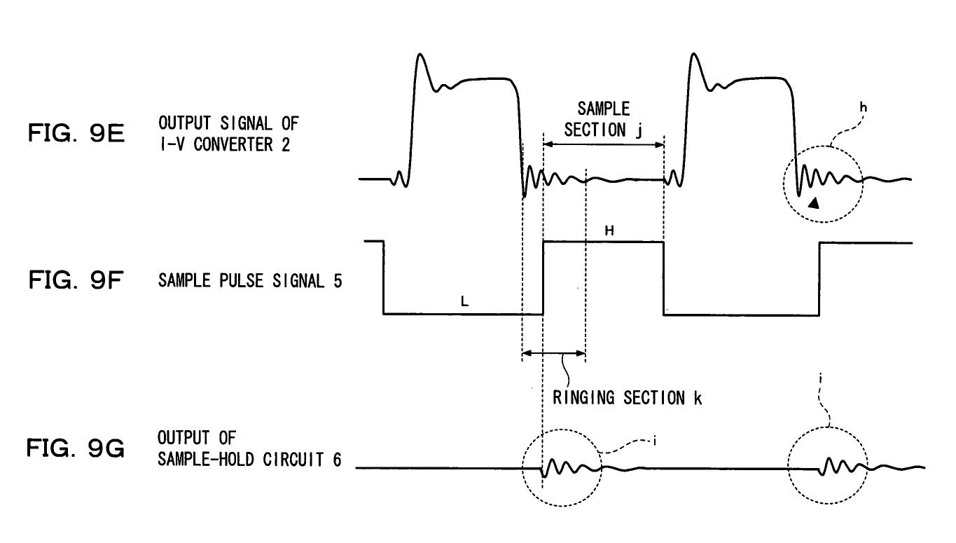

### BEST MODE FOR CARRYING OUT THE INVENTION

In the present invention, a stable recording operation is performed by excluding the ringing at the time of the variation, the ascent, and the descent in level from a wobble signal and an actuator control signal including a tracking error and a focus error for a high frequency part close to a ringing frequency at the time of a variation, an ascent, and a descent in level of an output signal of an I-V converter 2 by an output variation of a recording power of a light-receiving element 1, and a low frequency part close to a servo control band and a wobble signal band.

Hereinafter, embodiments of the present invention will be described with reference to the drawings. In addition, in an optical disc, a recording area is formed on a recording surface in a spiral pattern or in a concentric pattern.

### First Embodiment

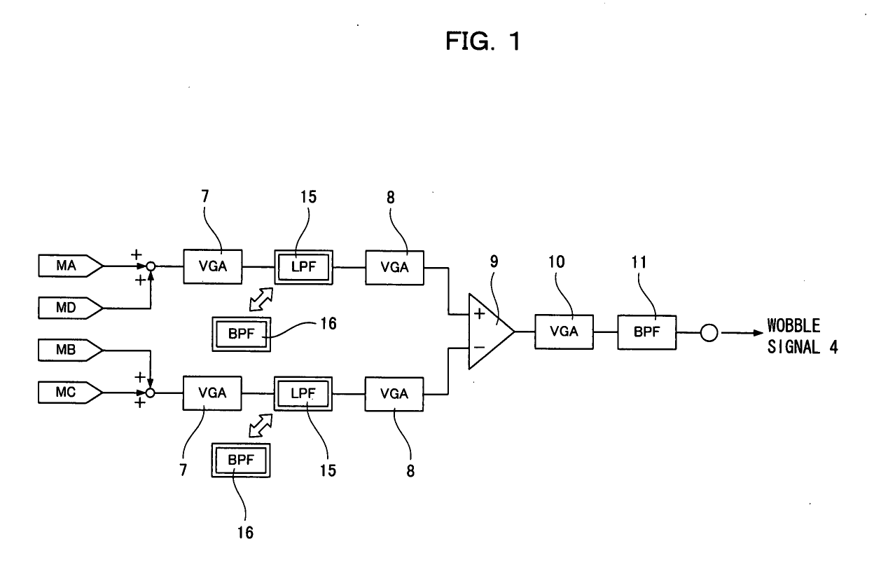

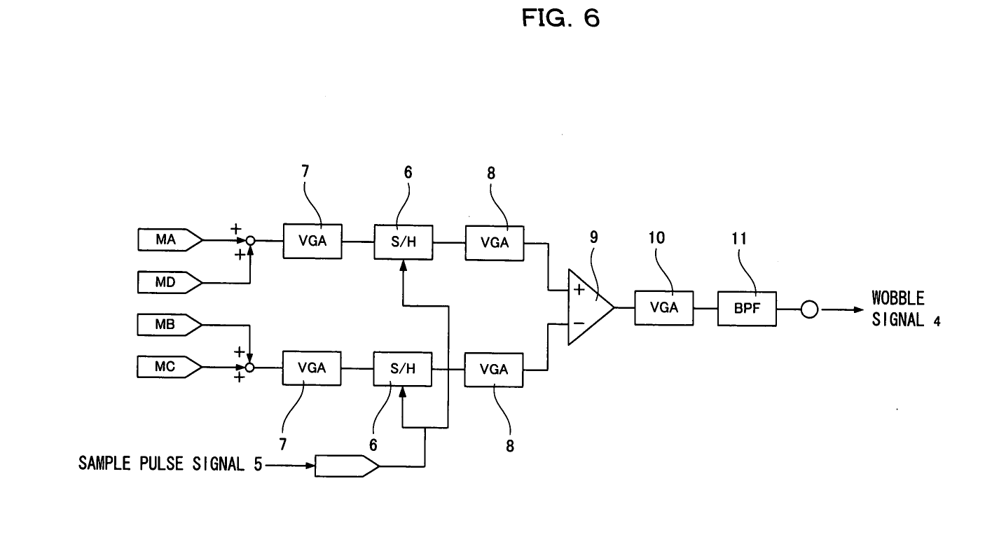

FIG. 1 is a block diagram of a wobble signal generating circuit (an example of a signal generating circuit) of an optical disc recording/reproducing apparatus according to a first embodiment of the present invention and shows a configuration of the wobble signal generating circuit in a lowpass filter (hereinafter, referred to as ‘LPF’) in case of an application of a recording operation in an optical disc using an organic dye. In addition, a same reference numeral is given to the same component as that of a known wobble signal generating circuit shown in FIG. 6.

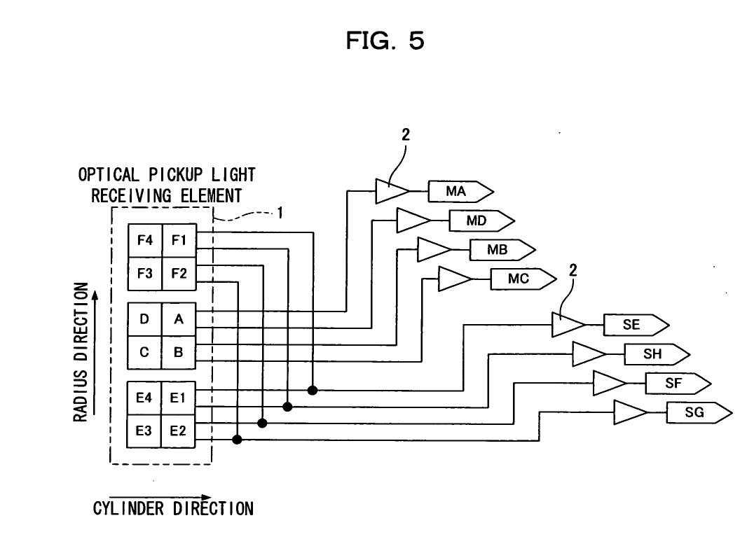

As shown in FIG. 1, in output signals MA, MB, MC, and MD of an I-V converter of FIG. 5, the output signals MA and MD are added to each other, and the output signals MB and MC are added to each other, thereby each being input to a VGA circuit 7. The output signals each are input to an LPF 15 for passing an only low frequency part close to a wobble signal band after an amplitude is adjusted by each VGA circuit 7 (after a gain-up and a gain-down of a predetermined amount of the output signals). Signals where the only low frequency part close to the wobble signal band is passed by the LPF 15 are adjusted in predetermined amplitude by a VGA 8. After the output signal of the VGA circuit 8 is subtracted by an error amplifier 9 and amplitudes thereof each are adjusted by a VGA circuit 10, an only signal of a wobble signal frequency band is extracted by a BPF 11, thereby generating a wobble signal 4. The wobble signal 4 is described by the following expression shown in Formula (1):
(MA+MD)−(MB+MC)=Wobble Signal 4 (1)

A frequency band of a recorded EFM signal is between 3 T:approximately 1.44 MHz and 11 T:approximately 393 KHz (clock pulse cycle) at 1 double speed, and the frequency band is approximately 393 KHz in 11 T recording at the lowest frequency. A frequency band of a wobble signal between 1 T:approximately 21.05 KHz and 3 T:approximately 23.05 KHz at 1 double speed, and the frequency band is approximately 21.05 KHz in 1 T reproducing at the highest frequency. As described above, there is a difference between a recorded EFM signal frequency and a reproduced wobble signal frequency. By this configuration, it is possible to output cut signal for a ringing frequency at the time of the ascent and the descent by a level variation of the output signal of the I-V converter 2 higher than the variation by the recording power in addition to a variation by a recording power of an output of a light receiving element synchronized with the EFM signal caused by recording by using an LPF 15 for passing an only frequency lower than the lowest frequency (393 KHz) out of frequency bands of the EPM signal including the frequency band of the wobble signal, for example, the LPF 15 for passing a frequency of 200 KHz or lower. Since a signal which does not have a noise and does not affect a record pulse is input at the time of being input to the VGA circuit 8, it is possible to reduce the acquisition error of address information and hence obtain a stable recording operation.

Instead of the LPF 15 used in the first embodiment, a band pass filter (hereinafter, referred to as ‘BPF’) 16 for passing an only frequency of a predetermined range of the wobble signal frequency band may be used. It is possible to output cut signal for a ringing frequency at the time of the ascent and the descent by a level variation of the output signal of the I-V converter 2 higher than the variation by the recording power in addition to a variation by a recording power of an output of a light receiving element synchronized with the EFM signal caused by recording by using the BPF 16 for passing an only frequency lower than the lowest frequency band (393 KHz) out of frequency bands of the EPM signal including the frequency band of the wobble signal, for example, the LPF 15 for passing a frequency band of 30 KHz to 10 KHz. Since a signal which does not have a noise and does not affect a record pulse is input at the time of being input to the VGA circuit 8, it is possible to reduce the acquisition error of address information and hence obtain a stable recording operation.

### Second Embodiment

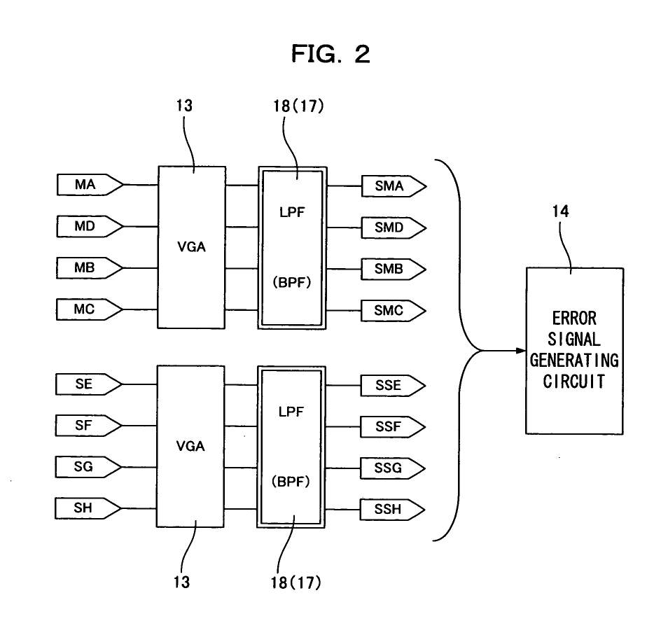

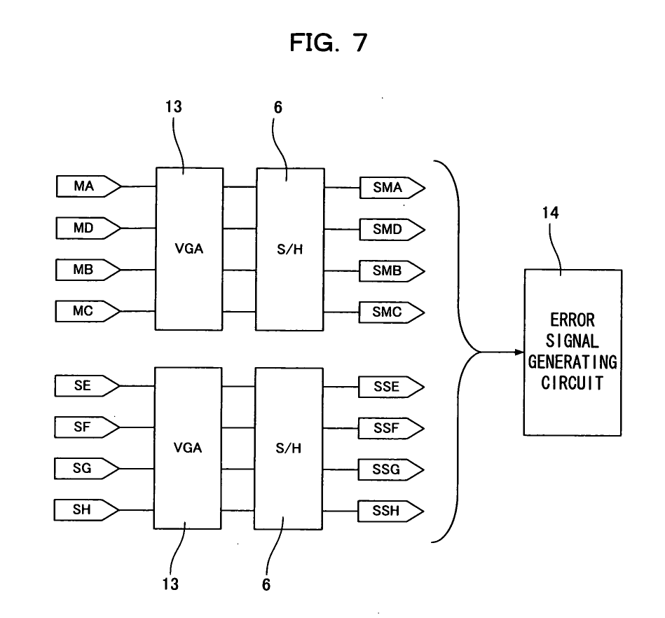

FIG. 2 is a block diagram of a servo signal generating circuit (an example of a signal generating circuit) of an optical disc recording/reproducing apparatus according to a second embodiment of present invention and shows a case of recording in a recording a recordable optical disc. In addition, a same reference numeral is given to the same component as that of the known servo signal generating signal shown in FIG. 7.

The output signals (MA, MB, MC, and MD) and (SE, SF, SG, and SH) of the I-V converter 2 shown in FIG. 5 are input to an LPF 18 for passing the only low frequency controlled by the actuator after amplitudes thereof each are adjusted by the VGA 13 (after the gain-up and the gain-down of a predetermined amount of the output signals).

The output signals (SMA, SMB, SMC, and SMD) and (SSE, SSF, SSG, and SSH) each are input to an error signal generating circuit 14 as an error signal representing a relative error at the time of a control of a laser beam to an information surface of the optical disc. Therefore, servo control signals (the tracking error signal and the focus error signal) shown in Formulas (2) and (3).

A frequency band of a recorded EFM signal is between 3 T:approximately 1.44 MHz and 11 T:approximately 393 KHz (clock pulse cycle) at 1 double speed, and the frequency band is approximately 393 KHz in 11 T recording at the lowest frequency. In a standard optical disc drive, a frequency band where the actuator can be controlled is approximately 100 KHz. That is, when the actuator control signal has a normal output frequency of approximately 100 KHz, it is not difficult to control the actuator. Since there is a difference between the EFM signal frequency and the actuator control frequency recorded above, it is possible to output cut signal for a ringing frequency at the time of the ascent and the descent by a level variation of the output signal of the I-V converter 2 higher than the variation by the recording power in addition to a variation by a recording power of an output of a light receiving element synchronized with the EFM signal caused by recording by using an LPF 18 for passing an only frequency lower than the lowest frequency (393 KHz) out of frequency bands of the EPM signal including the frequency band where the actuator can be controlled, for example, the LPF 18 for passing a frequency of 200 KHz or lower. Since a signal which does not have a noise and does not affect a record pulse is input at the time of being input to the error signal generating circuit 14, the noise is not superimposed on the servo control signal (the actuator control signal) and the servo signal which does not have the noise is generated. Therefore, it is possible to obtain the stable recording operation.

Instead of the LPF 18 used in the second embodiment, a BPF 17 for passing an only frequency band where the actuator can be controlled may be used. It is possible to output cut signal for a ringing frequency at the time of the ascent and the descent by the level variation of the output signal of the I-V converter 2 higher than the variation by the recording power in addition to a variation by a recording power of an output of a light receiving element synchronized with the EFM signal caused by recording by using the BPF 17 for passing an only frequency lower than the lowest frequency band (393 KHz) and where the actuator can be controlled, for example, the LPF 17 for passing a only frequency band of 10 KHz to 120 KHz. Since a signal which does not have a noise and does not affect a record pulse is input at the time of being input to the error signal generating circuit 14, the servo signal which does not have the noise is generated. Therefore, it is possible to obtain the stable recording operation.

### Third Embodiment

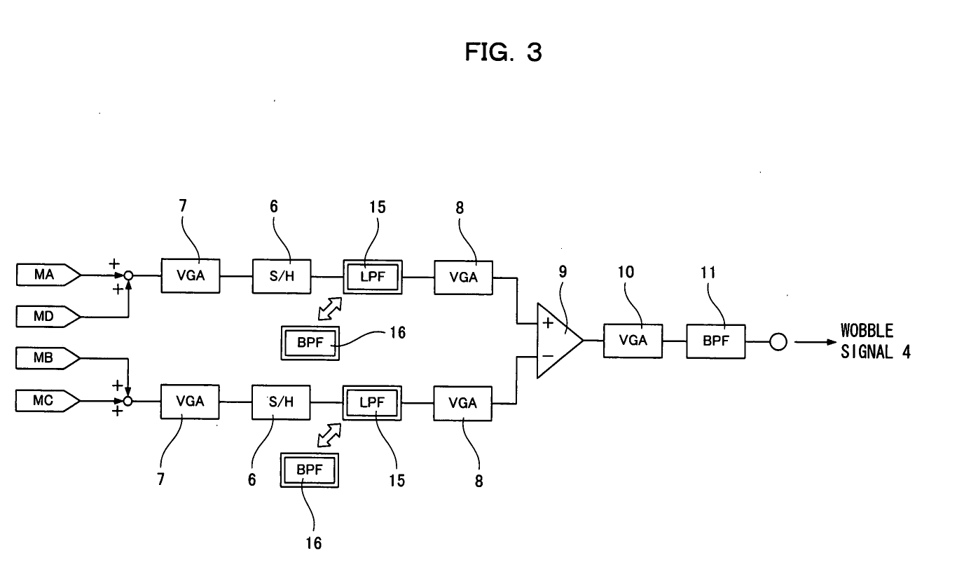

Hereinafter, a third embodiment of the present invention will be described with reference to FIG. 3. In the third embodiment, the sample-hold circuit 6 shown in FIG. 6 is inserted between the VGA 7 and the LPF 15 of the first embodiment.

By this configuration, a variation area by the recording power of the light receiving element synchronized with the EFM signal caused by recording is eliminated by the sample-hold circuit 6, the ringing frequency at the time of the ascent and the descent by the level variation of the output signal of the I-V converter 2 is eliminated from the signal of the sample-hold circuit 6 by the LPF 15. That is, since a signal which does not have a noise and does not affect a record pulse is input at the time of being input to the VGA 8, it is possible to reduce the acquisition error of address information and hence obtain the stable recording operation.

Instead of the LPF 15 used in the third embodiment, the BPF 17 may be used. By this configuration, the variation by the recording power of the light receiving element synchronized with the EFM signal caused by recording is eliminated by the sample-hold circuit 6, and the ringing frequency at the time of the ascent and the descent by the level variation of the output signal of the I-V converter 2 is eliminated from the signal of the sample-hold circuit 6 by the BPF 16. That is, since a signal which does not have a noise and does not affect a record pulse is input at the time of being input to the VGA 8, it is possible to reduce the acquisition error of address information and hence obtain the stable recording operation.

### Fourth Embodiment

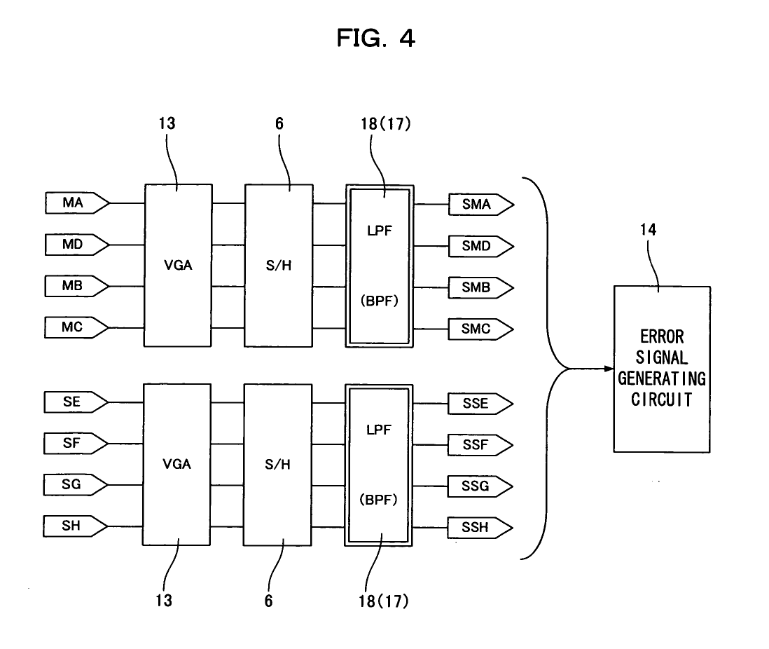

Hereinafter, a fourth embodiment of the present invention will be described with reference to FIG. 4. In the fourth embodiment, the sample-hold circuit 6 shown in FIG. 7 is inserted between the VGA 13 and the LPF 18 of the second embodiment.

By this configuration, the variation area by the recording power of the light receiving element synchronized with the EFM signal caused by recording is eliminated by the sample-hold circuit 6, and the ringing frequency at the time of the ascent and the descent by the level variation of the output signal of the I-V converter 2 is eliminated from the signal of the sample-hold circuit 6 by the LPF 18. Accordingly, since a signal which does not have a noise and does not affect a record pulse is generated at the time of being input to the error signal generating circuit 14, the noise is not superimposed on the servo signal and the servo signal which does not have the noise is generated. Therefore, it is possible to obtain the stable recording operation.

Instead of the LPF 18 used in the fourth embodiment, the BPF 17 may be used. By this configuration, the variation area by the recording power of the light receiving element synchronized with the EFM signal caused by recording is eliminated by the sample-hold circuit 6, and the ringing frequency at the time of the ascent and the descent by the level variation of the output signal of the I-V converter 2 is eliminated from the signal of the sample-hold circuit 6 by the BPF 17. Accordingly, since a signal which does not have a noise and does not affect a record pulse is input at the time of being input to the error signal generating circuit 14, the noise is not superimposed on the servo signal and the servo signal the noise which does not have the noise. Therefore, it is possible to obtain the stable recording operation.

Further, the fourth embodiment is applied to the optical disc where the recording area is formed on the recording surface in a spiral pattern or in a concentric pattern and the recording area is meandered. However, the second embodiment and the fourth embodiment are not limited to the optical disc where the wobble is formed and may be applied to an optical disc capable of recording data.

### INDUSTRIAL APPLICABILITY

A signal generating circuit of an optical disc recording/reproducing apparatus according the present invention reduces an acquisition error of address information and does not generate a servo signal which does not have a noise, thereby obtaining a stable recording operation, and is useful in a technical field in which data or addresses are recorded in a DVD or a CD.

1. A signal generating circuit of an optical disc recording/reproducing apparatus for detecting a wobble signal based on a meander of a recording area on the basis of signals of a light receiving element of an optical pickup which receives a reflective light from a recording surface of a spot light radiated to an optical disc where the recording area is formed in a spiral pattern or in a concentric pattern, the signal generating circuit comprising:
one of a lowpass filter for passing only lower parts of frequencies close to a wobble signal band according to the signals of the light receiving element and a bandpass filter for passing only frequencies within a predetermined range of a wobble signal frequency band according to the signals of the light receiving element,
wherein an affect of record pulses superimposed on the signals from the light receiving element is eliminated by one of the lowpass filter and the bandpass filter.

2. The signal generating circuit of the optical disc recording/reproducing apparatus according to claim 1, further comprising a sample-hold circuit for sampling the signals of the light receiving element, wherein
output signals of the sample-hold circuit are input to one of the lowpass filter and the bandpass filter,
a variation area by a recording power is eliminated by the sample-hold circuit according to the signals of the light receiving element, and
a ringing frequency upon ascent and decent by a level variation is eliminated by the lowpass filter and the bandpass filter according to the signals of the sample-hold circuit.

3. A signal generating circuit of an optical disc recording/reproducing apparatus for generating and outputting an error signal representing a relative error involved in a control of a laser beam to an information surface of an optical disc, based on signals of the light receiving element of an optical pickup for radiating a spot light to an information recording surface of a recordable optical disc and detecting a reflective light from the information recording surface, the signal generating circuit comprising:
one of a lowpass filter for passing only lower parts of frequencies where an actuator control can be performed according to the signals of the light receiving element and a bandpass filter for passing only frequency band where the actuator control can be controlled according to the signals of the light receiving element, wherein
an affect of record pulses superimposed on the signals from the light receiving element is eliminated by one of the lowpass filter and the bandpass filter.

4. The signal generating circuit of the optical disc recording/reproducing apparatus according to claim 3, further comprising a sample-hold circuit for sampling the signals of the light receiving element, wherein
output signals of the sample-hold circuit are input to one of the lowpass filter and the bandpass filter,
a variation area by a recording power is eliminated by the sample-hold circuit according to the signals of the light receiving element, and
a ringing frequency upon ascent and decent by a level variation is eliminated by the lowpass filter and the bandpass filter according to the signals of the sample-hold circuit.
